(19) United States
(12) Patent Application Publication
(10) Pub. No.: US 2007/0085687 A1
(43) Pub. Date: Apr. 19, 2007

(54) Projector

(75) Inventors: Chien-Wu Yen, Miao-Li (TW); Tzu-Hai Chung, Miao-Li (TW)

Correspondence Address: BACON & THOMAS, PLLC, 625 SLATERS LANE, FOURTH FLOOR, ALEXANDRIA, VA, 22314, US

(73) Assignee: CORETRONIC CORPORATION, Hsinchu (TW)

(21) Appl. No.: 11/520,719

(22) Filed: Sep. 14, 2006

(30) Foreign Application Priority Data
Oct. 17, 2005 (TW) 94136210

(51) Int. Cl. G08B 13/14; G05B 19/00; G06K 19/06

(52) U.S. Cl. 340/572.8; 235/492; 340/5.61

(57) ABSTRACT

A projector comprising a main body, a radio frequency identification (RFID) tag and a controller is provided. The main body comprises a light module and an optical engine. The light module is used for emitting a light. The optical engine is used for receiving the light and outputting a projecting image. The RFID tag is coupled to the main body and is used for providing an identification data to recognize the identity of the projector or a user. The controller reads the identification data from the radio frequency identification tag or writes the identification data to the radio frequency identification tag by a communication interface.

This application claims the benefit of Taiwan application Ser. No. 94136210, filed Oct. 17, 2005, the subject matter of which is incorporated herein by reference.

### BACKGROUND OF THE INVENTION

1. Field of the Invention

The invention relates in general to a projector, and more particularly to a projector with radio frequency identification function.

2. Description of the Related Art

As the radio frequency identification technology is getting more and more popular and matured, the radio frequency identification technology is applied to more and more electronic produces. However, how to incorporate the radio frequency identification technology with a projector such that the projector provides convenience and more functions enabled by the radio frequency identification technology to a user or bring down the manufacturing cost has become an imminent issue to be resolved.

When the conventional projector is having wireless transmission with a host, the host is unable to directly recognize the identity of the projector. The software of the host searches the projectors currently in this area first and assigns an identification code (ID) to the projectors one by one next. At last, the host performs wireless transmission with a particular projector according to the identification code.

### SUMMARY OF THE INVENTION

It is therefore an object of the invention to provide a projector with radio frequency identification function. The radio frequency identification (RFID) tag is disposed inside the projector, such that the projector is equipped with the functions enabled by the radio frequency identification technology.

The invention achieves the above-identified object by providing a projector with radio frequency identification function. The projector with radio frequency identification function comprises a main body, an RFID tag and a controller. The main body comprises a light source module and an optical engine. The light source module is used for emitting a light. The optical engine is used for receiving the light and projecting an image light. The RFID tag is coupled to the main body and is used for providing an identification data to recognize an identity of the projector or a user. The controller reads the identification data from the radio frequency identification tag or writes the identification data to the radio frequency identification tag by a communication interface.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a projector with radio frequency identification function according to a preferred embodiment of the invention.

### DETAILED DESCRIPTION OF THE INVENTION

The invention provides a projector with radio frequency identification function. The radio frequency identification (RFID) tag is disposed in the projector, such that the projector is equipped with the functions enabled by the radio frequency identification technology

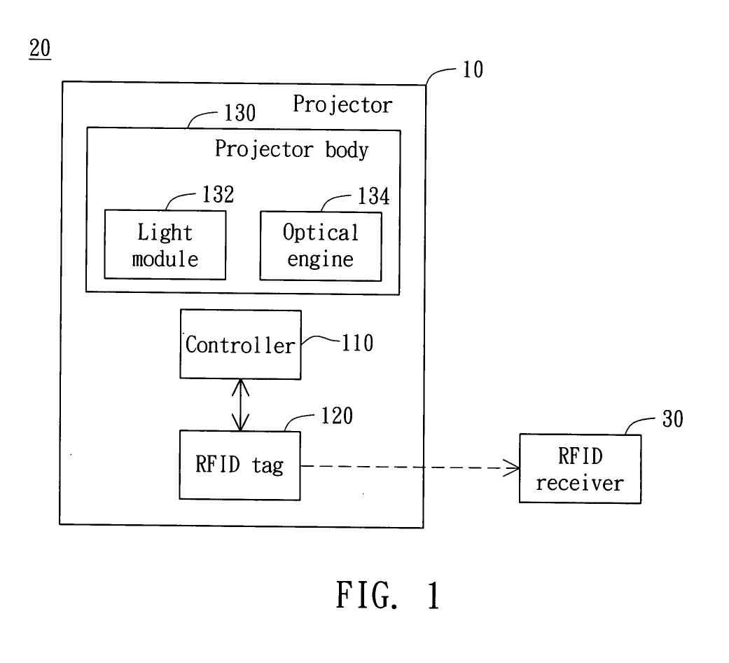

Referring to FIG. 1, a block diagram of a projector with radio frequency identification function according to a preferred embodiment of the invention is shown. A radio frequency identification system 20 comprises a projector 10 and a receiver 30. The projector 10, for example, includes a rear projector and a front projector. The projector 10 comprises a main body 130, a radio frequency identification (RFID) tag 110 and a controller 120. The main body 130 comprises a light source module 132 and an optical engine 134. The light source module 132 is used for emitting a light. The optical engine 134 is used for receiving the light and projecting an image light. The light source module comprises a lamp and a lamp shade. The optical engine comprises a light pipe, a lens, a reflective mirror, an image module and a projection lens. The light emitted by the lamp is reflected by the lamp shade first to pass through optical elements, and then a projecting image is projected by a projection lens. The optical elements, for example, include the light pipe, the lens, the reflective mirror and the image module. The image module, for example includes a digital micro-mirror device (DMD) and a liquid crystal display (LCD) panel.

RFID tag 110 is coupled to the main body 130 for providing an identification data to recognize an identity of the projector 10 or a user. The controller 120 reads the identification data from the radio frequency identification tag or writes the identification data to the radio frequency identification tag 110 by a communication interface. The communication interface includes RS232, I2C, I2S and GPIO, for example. The receiver 30 is used for the user to read the identification data from the RFID tag 110. The identification data, for example includes password data, time data or identification code (ID) of the projector 10.

Furthermore, with the RFID tag 110 being disposed inside the projector 10, the password and the time are set without using additional memory, and the projector is equipped with several wireless identity recognition functions without using any other communication protocols. For example, in terms of the setting of the password, for a conventional projector to be equipped with the functions of password setting, an additional memory and an associated control circuit are required for the storage of the password and the execution of relevant functions. The invention uses the memory of the RFID tag 110 for the user to set a password in the projector 10, such that the password has to be inputted first before the projector 10 executes various functions. If the inputted password does not match with the password of the RFID tag 110, the projector 10 terminates the functions immediately. Compared with the conventional projector which requires an additional memory for the setting of password, the projector of the invention saves manufacturing cost and increases competitivity.

In terms of the setting of time, for a conventional projector to be equipped with time setting function, an additional memory is required to store the time data. Similarly, the projector 10 achieves the time setting function by using the memory of the RFID tag 110. For example, before leasing the projector 10 to a client, a lesser writes the time data to the RFID tag 110 according to the duration of the lease. When the duration of the lease is due, the projector 10 automatically shuts down all functions such that the user is unable to use the projector 10 any more. Compared with the conventional projector which requires an additional memory, the projector 10 of the invention saves manufacturing cost and increases competitivity.

When the the projector 10 is having wireless transmission with a host. According to the preferred embodiment of the invention, the RFID tag 110 is disposed inside the projector 10, such that the projector 10 achieves the identity recognition function by the RFID tag 110. The projector 10 writes the identification code to the RFID tag 110 by a controller 120. Thus, after the host reads the identification code from the RFID tag 110, the host is able to have wireless transmission with the projector 10 and correctly transmits the image data to the projector 10 according to the identification code of the RFID tag 110.

In terms of warehouse management, with the RFID tag being built in the projector 10, not only the warehousemen are able to calculate the inventory level by using a receiver 30 to sense the RFID tag 110, but also the RFID tag 110 is prevented from being damaged by any external impact which may disable the original radio frequency identification function.

The projector with radio frequency identification function disclosed in the above embodiment disposes the RFID tag inside the projector and has the following advantages:

The first advantage of the invention is that the manufacturing cost is reduced and the competivity is increased. By writing the time data and the password data to the RFID tag, not additional memory is required to store the time data and the password data, such that the manufacturing cost is reduced and the competivity is increased.

The second advantage of the invention is that the projector has identity recognition function. When the projector is having wireless transmission with the host, by writing the identification code into the RFID tag, the host correctly transmits the image data to the projector 10 according to the identification code of the RFID tag 110 such that the identity of the projector is identified without using the software of the host.

The third advantage of the invention is that the RFID tag is protected. By disposing the RFID tag inside the projector, the RFID tag 110 is prevented from receiving any external impact which is without the original radio frequency identification functions.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A projector, comprising:
a main body, comprising:
a light source module used for emitting a light; and
an optical engine used for receiving the light and projecting an image light;
a radio frequency identification (RFID) tag coupled to the main body for providing an identification data to recognize an identity of the projector or a user; and
a controller used for reading the identification data from the RFID tag or writing the identification data to the RFID tag by a communication interface.

2. The projector according to claim 1, wherein the RFID tag wirelessly receives the identification data to recognize the identity of the projector or the user by a radio frequency identification (RFID) receiver.

3. The projector according to claim 1, wherein the communication interface is an RS232.

4. The projector according to claim 1, wherein the communication interface is an I2C.

5. The projector according to claim 1, wherein the communication interface is an I2S.

6. The projector according to claim 1, wherein the communication interface is a GPIO.

7. The projector according to claim 1, wherein the controller writes a password data to the RFID tag.

8. The projector according to claim 1, wherein the controller writes a time data to the RFID tag.
